(19) United States
(12) Patent Application Publication
(10) Pub. No.: US 2011/0178856 A1
(43) Pub. Date: Jul. 21, 2011

(54) SYSTEM AND METHOD FOR SHARING WITH REGISTERED USERS REVENUE GENERATED BY ADVERTISEMENTS DISPLAYED WITH CONTENT

(75) Inventor: Haven Lorenzini Micaelian, Menlo Park, CA (US)

(73) Assignee: Haven Lorenzini Micaelian and Marcantonio Parisi

(21) Appl. No.: 12/690,383

(22) Filed: Jan. 20, 2010

(51) Int. Cl. G06Q 30/00; G06Q 10/00; G06F 21/00; G06F 17/30

(52) U.S. Cl. 705/14.17; 705/14.25; 705/14.36; 726/3; 707/706; 707/E17.108

(57) ABSTRACT

Systems and methods for sharing advertisement payment revenues with users of a search engine, as well as other user content recipients are disclosed. A user's general profile is established by tracking usage of the system by the user. The user general profiles are used to better target advertisements and enhance suitability of search results. User participation in establishing a comprehensive profile is encouraged by providing monetary or other types of incentives based upon a user's search engine usage and responses to served advertisements.

### TECHNICAL FIELD

The present disclosure relates to the fields of search engines, advertising, and providing remuneration to users of a search engine system, or any other application or system, that serves targeted advertisements to users.

### BACKGROUND

Web search engines are traditionally supported by advertising revenue. Typically, advertisers pay a fee to have their advertisements displayed alongside search engine results. Advertisers can bid on keyword phrases relevant to their target market. In one advertising model, pay per click (PPC), advertisers pay the fee only when an advertisement is clicked upon. In another advertising model, cost per click (CPC), advertisers pay a fixed amount for each click on an advertisement that brings a visitor to the advertiser's website. In yet another advertising model, pay per placement, advertisers pay a fixed fee each time an advertisement is displayed with a search result.

### SUMMARY

Revenues are generated by search engines or other ad supported applications from the placement of advertisements alongside search results. By capturing the general profiles of users of the search engine or application, advertisements can be better targeted. Moreover, search results can also be enhanced. A user's general profile is established by having users answer a questionnaire and by tracking usage of the system by the user. Voluntary participation is encouraged by providing monetary or other types of incentives based upon search engine or application usage and responses to served advertisements. A portion of the advertising revenue generated from advertisers directly supports user incentives.

### BRIEF DESCRIPTION OF THE DRAWINGS

Examples of a revenue sharing system and method associated with a search engine are illustrated in the figures. The examples and figures are illustrative rather than limiting.

FIG. 1 depicts an example of a traditional search engine result that includes advertisements in the search results page.

FIG. 2A depicts a block diagram of a plurality of client devices, advertisers, and a host server coupled via a network, according to one embodiment.

FIG. 2B depicts a block diagram illustrating an example system for acquiring user information to be used in conjunction with providing advertisements with search engine results, the system to include a host server coupled to a user database, and/or an advertiser database, and/or an advertisement database, and/or a general ledger, according to one embodiment.

FIG. 3A depicts a block diagram illustrating an example of a user database that stores user information and user account information, according to one embodiment.

FIG. 3B depicts a block diagram illustrating an example of an advertiser database that stores advertiser information and advertiser account information, according to one embodiment.

FIG. 3C depicts a block diagram illustrating an example of an advertisement database that stores advertisement profile information, advertisement content, and advertisement interaction log, according to one embodiment.

FIG. 3D depicts a block diagram illustrating an example of a general ledger database that stores account information, according to one embodiment.

FIG. 4A depicts a flow diagram illustrating an exemplary process of permitting an advertiser to securely log in to the host server to set or update advertisement parameters, according to an embodiment of the disclosure.

FIG. 4B depicts a flow diagram illustrating an exemplary process of permitting a registered user to log in to the host server to perform a search, according to an embodiment of the disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description.

Without intent to further limit the scope of the disclosure, examples of instruments, apparatus, methods and their related results according to the embodiments of the present disclosure are given below. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification including examples of any terms discussed herein is illustrative only, and is not intended to further limit the scope and meaning of the disclosure or of any exemplified term. Likewise, the disclosure is not limited to various embodiments given in this specification. For example, the specific embodiment of a search engine is referenced throughout the Detailed Description, however the methods and systems described herein can be implemented in any ad supported application, such as, email or games.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

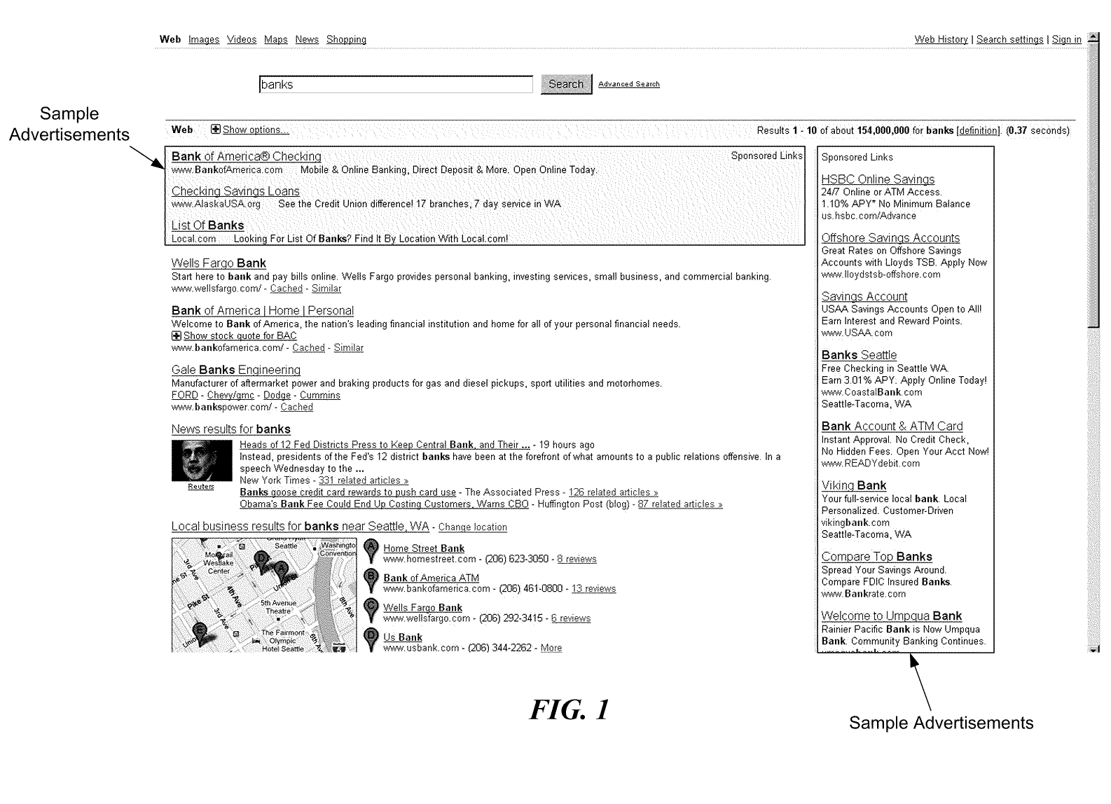

Today, many web-based search engines place online advertisements in a variety of formats and media on web pages that show the results of search queries. One example of a search engine result page that includes advertisements is shown in FIG. 1. Advertisers pay to target their advertisements to users who conduct searches with search terms that match certain keywords. However, advertisement revenues earned by the search engines from advertisers are not shared with the users of the search engine who are subjected to the advertisements.

In order to better target advertisements to users who may be looking to purchase particular products or services, it would be useful to understand the general profile of the users of the search engine. This kind of information can be acquired in many ways, for example, by requesting that users fill out a questionnaire as completely as possible and tracking search engine queries of users, advertisements served to users, and users' responses to the queries and advertisements. One way of encouraging users to cooperate with providing needed information is by sharing advertising revenue with compliant users or providing other types of incentives. The more information that a user provides, the greater the compensation the user will receive. Additionally, the information accumulated by the system about a particular user can be used to enhance the search results provided to the user. For example, search results can be presented to the user according to the most likely information the user may be looking for.

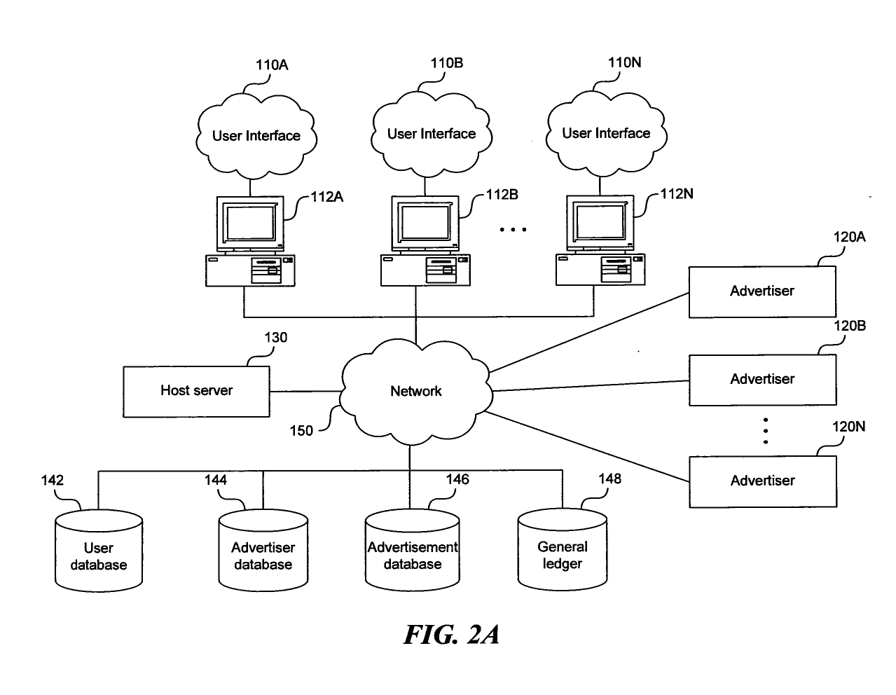

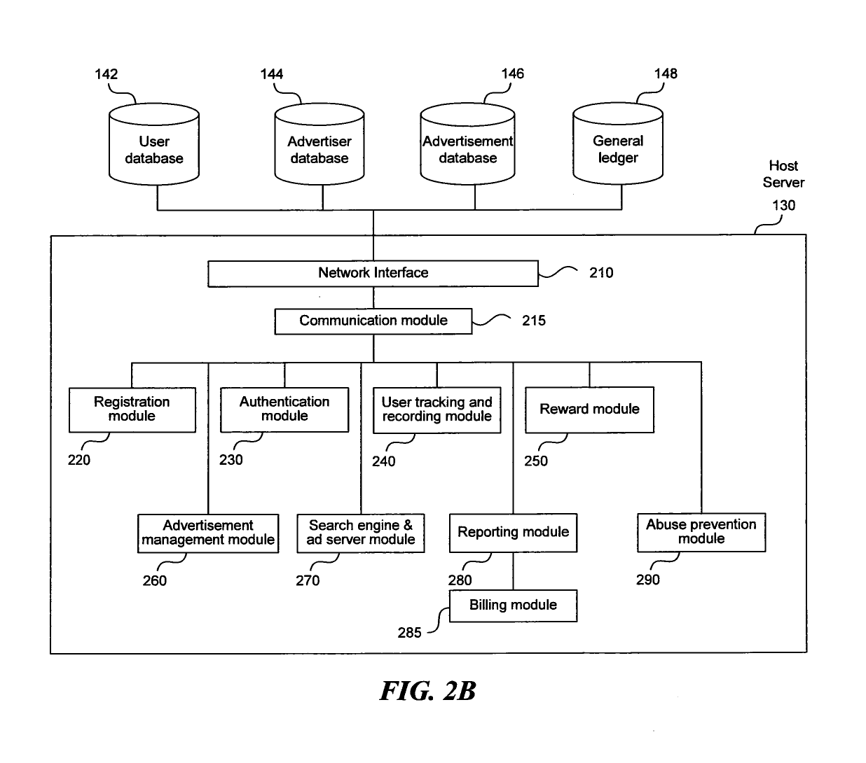

FIG. 2A illustrates a block diagram of a plurality of client devices 112A-N, advertisers 120A-N, and a host server 130 coupled via a network 150, according to one embodiment.

The plurality of client devices 112A-N can be any system and/or device, and/or any combination of devices/systems that is able to establish a connection with another device, a server and/or other systems. The client devices 112A-N typically include a user interface 110A-N that includes an input device or devices and a display or other output functionalities to present data exchanged between the devices to a user. For example, the client devices can include, but are not limited to, a server desktop, a desktop computer, a computer cluster, a mobile computing device such as a notebook, a laptop computer, a handheld computer, a mobile phone, a smart phone, a PDA, a BlackBerry™ device, a Treo™, and/or an iPhone, etc. In one embodiment, the client devices 112A-N are coupled to a network 150.

The network 150, to which the client devices 112A-N are coupled, can be a telephonic network, an open network, such as the Internet, or a private network, such as an intranet and/or the extranet. For example, the Internet can provide file transfer, remote log in, email, news, RSS, and other services through any known or convenient protocol, such as, but not limited to the TCP/IP protocol, Open System Interconnections (OSI), FTP, UPnP, iSCSI, NSF, ISDN, PDH, RS-232, SDH, SONET, etc.

The network 150 can be any collection of distinct networks operating wholly or partially in conjunction to provide connectivity to the client devices and host server, and can appear as one or more networks to the serviced systems and devices. In one embodiment, communications to and from the client devices 112A-N can be achieved by, an open network, such as the Internet, or a private network, such as an intranet and/or the extranet.

The client devices 112A-N can be coupled to the network (e.g., Internet) via a dial-up connection, a digital subscriber loop (DSL, ADSL), cable modem, and/or other types of connection. Thus, the client devices 112A-N can communicate with remote servers (e.g., web server, host server, mail server, or instant messaging server) that provide access to user interfaces of the World Wide Web via a web browser, for example.

The user database 142, advertiser database 144, advertisement database 146, and general ledger 148 can store information such as software, descriptive data, images, system information, drivers, and/or any other data item utilized by parts of the host server 130 for operation. The user database 142, advertiser database 144, advertisement database 146, and general ledger 148 can be managed by a database management system (DBMS), for example but not limited to, Oracle, DB2, Microsoft Access, Microsoft SQL Server, PostgreSQL, MySQL, FileMaker, etc.

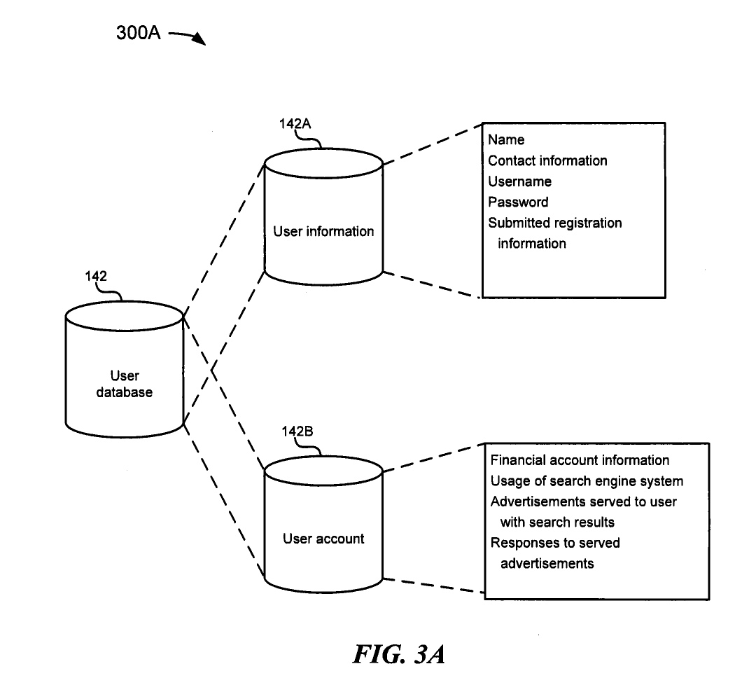

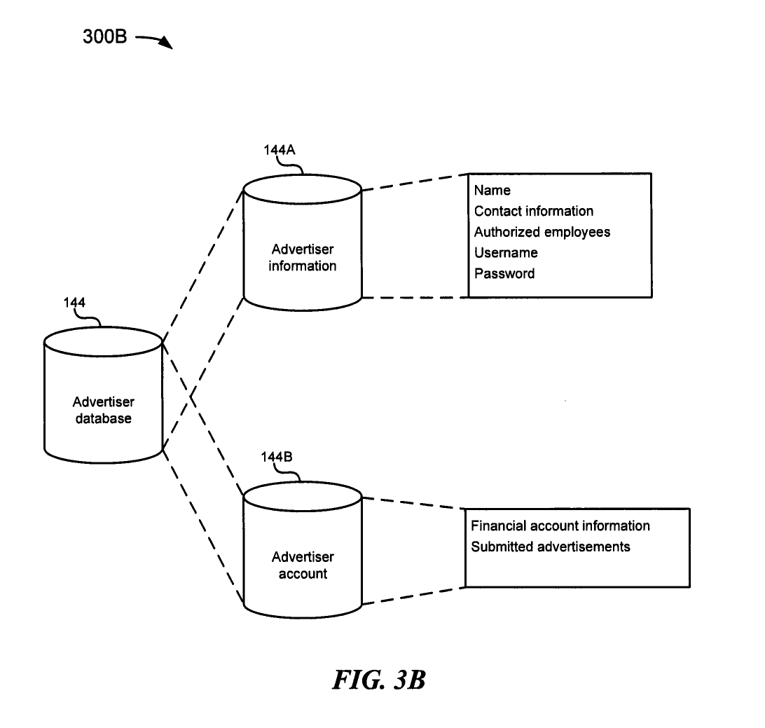

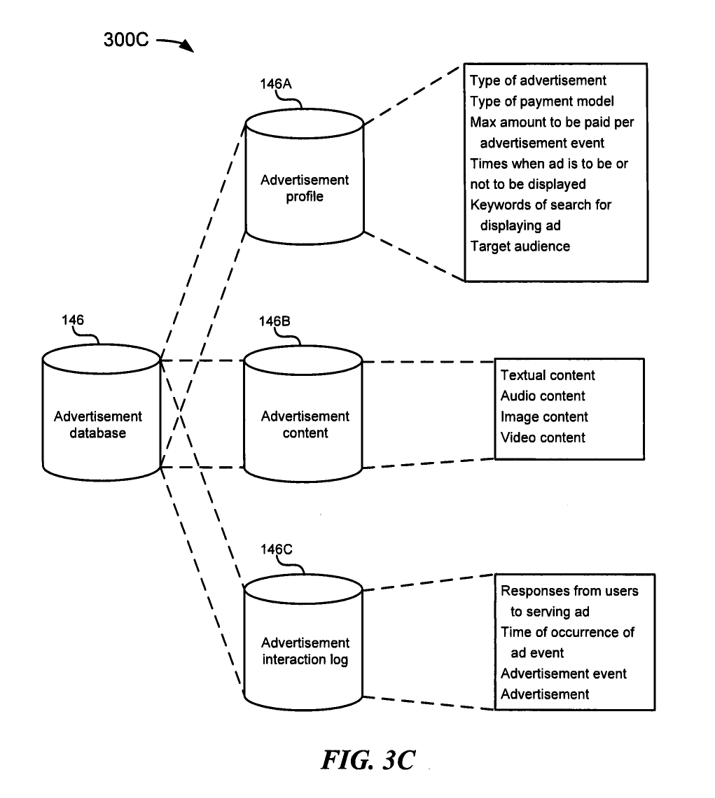

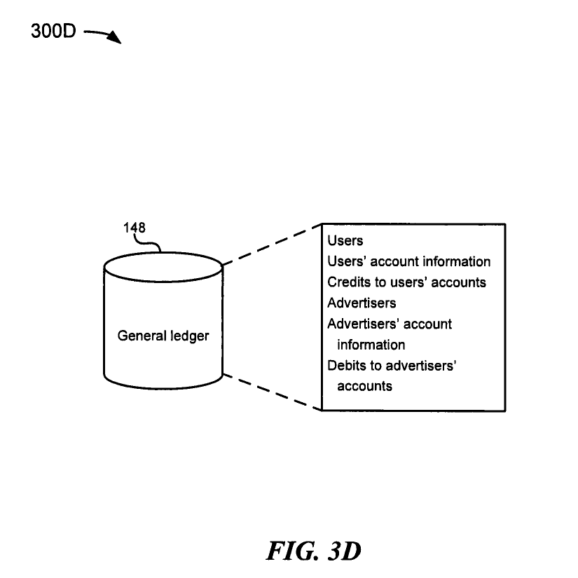

The databases 142, 144, 146, and 148 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the user database 142, advertiser database 144, advertisement database 146, and general ledger 148 is further illustrated in FIGS. 3A-3D.

The host server 130 is able to communicate with client devices 112A-N and advertisers 120A-N via the network 150. In addition, the host server 130 is able to retrieve from and store data to user database 142, advertiser database 144, advertisement database 146, and general ledger 148. Client devices 112A-N can access the host server 130 to perform searches. Advertisers 120A-N can access the host server 130 to submit advertisements and advertisement profile information.

FIG. 2B depicts a block diagram illustrating an example system for acquiring user information to be used in conjunction with providing advertisements with search engine results, the system to include a host server 130 coupled to a user database 142, and/or an advertiser database 144, and/or an advertisement database 146, and/or a general ledger 148, according to one embodiment.

In the example of FIG. 2B, the host server 130 includes a network interface 210, a registration module 220, an authentication module 230, a user tracking and recording module 240, a reward module 250, an advertisement management module 260, a search engine and advertisement server module 270, a reporting module 280, a billing module 285, and an abuse prevention module 290. Additional or fewer modules can be included. The host server 130 can be communicatively coupled to the user database 142, and/or an advertiser database 144, and/or an advertisement database 146, and/or a general ledger 148 as illustrated in FIG. 2B. In some embodiments, the user database 142, and/or the advertiser database 144, and/or the advertisement database 146, and/or the general ledger 148 are partially or wholly internal to the host server 130.

In the example of FIG. 2B, the network interface 210 can be one or more networking devices that enable the host server 130 to mediate data in a network with an entity that is external to the server, through any known and/or convenient communications protocol supported by the host and the external entity. The network interface 210 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

In the example of FIG. 2B, the host server 130 includes the communications module 215 communicatively coupled to the network interface 210 to manage a communication session over a plurality of communications protocols. In one embodiment, the communications module 215 receives data (e.g., audio data, textual data, audio files, etc.), information, commands, requests (e.g., text and/or audio-based), and/or text-based messages over a network.

Since the communications module 215 is typically compatible with receiving and/or interpreting data originating from various communication protocols, the communications module 215 is able to establish parallel and/or serial communication sessions with users of remote client devices for data and command exchange (e.g., user information and/or user content).

One embodiment of the host server 130 includes a registration module 220. The registration module 220 can be any combination of software agents and/or hardware components able to register new users and/or advertisers with the system and to create new accounts with the system. Each user of the search system should have an account so that the system can track the user's usage of the system and track compensation to the user for participating in targeted advertising. Further, each advertiser with the system should have an account for tracking at least submitted advertisements, advertisement profile information, responses, and advertisement fees.

In some embodiments, a new user can be asked to consent to the tracking and recording of his usage of the system, including submitted search queries, advertisements served with search results, and the user's responses to the advertisements and/or search results. The user is informed that maintaining the user's tracking information serves to enhance the quality of search results over time and the relevance of the served advertisements to the user also increases. In return for registering and permitting tracking information to be acquired by the system, incentives, either monetary or otherwise, are offered.

In some embodiments, new users are requested to provide answers to a questionnaire before being permitted to register. The answers allow the system to better target advertisements to users and also enhance search results due to a better understanding of the general profile of users who conduct searches with the system. By better targeting advertisements, advertisers are more likely to pay to advertise with the search engine system, or even to pay a premium to advertise. Consequently, more revenue becomes available to share with the registered users of the search engine system to compensate the users for divulging personal information and for agreeing to be served targeted advertisements.

In some embodiments, creation of an account for a new user includes obtaining personal information about the user such as name, address, etc., and a financial account where accounting information is registered, e.g. a bank account, credit card account, or an electronic cash or equivalent account. In some embodiments, prior to activating a new user account, approval from the system administrator is needed. In one embodiment, the system provides a username and password. Alternatively, the user selects a unique username and password. The creation of a unique account prevents duplication of accounts.

In some embodiments, creation of an account for a new advertiser includes obtaining information about the advertiser, such as name, address, employees authorized to submit advertisements and change advertisement profile information, and a financial account to be used for paying for served advertisements. In some embodiments, prior to activating a new advertiser account, approval from the system administrator is needed. In one embodiment, the system provides a username and password. Alternatively, the user selects a unique username and password.

In some embodiments, advertisers are informed that although advertisement costs may be affected by the payment of a portion to registered users, there are several benefits to the system including better targeting of advertisements to potentially interested customers arising from user tracking information and increased user traffic due to the incentives offered by the system.

One embodiment of the host server 130 includes an authentication module 230. The authentication module 230 can be any combination of software agents and/or hardware components able to authenticate users and advertisers. In some embodiments, authentication occurs by associating each user's username and password with an existing user account and/or associating each advertiser's username and password with an existing advertiser account. Unauthorized users and/or advertisers can be directed to register with the system. In some embodiments, unauthorized users can be permitted to perform searches without registering. However, unregistered users are not provided with any compensation.

One embodiment of the host server 130 includes an advertisement management module 260. The advertisement management module 260 can be any combination of software agents and/or hardware components able to set up advertisement parameters based upon advertisement profile information submitted for each advertisement by the advertiser, such as the content of the advertisement (e.g., image, audio, video, text, etc.), the type of advertisement payment model (e.g., PPC, CPC, or “eyeball”), the maximum amount the advertiser is willing to pay per advertisement event (e.g., a daily, weekly, or monthly limit, or overall limit for each advertisement), a preferred target audience (e.g., based on profile, location, etc.), and the setting of the advertisement (e.g., times at which the advertisement is to be displayed or not displayed).

One embodiment of the host server 130 includes a search engine and advertisement server module 270. The search engine and advertisement server module 270 can be any combination of software agents and/or hardware components able to perform a web search based upon a user's search query. Based upon the keywords used in the search query and information obtained by the user tracking and recording module 240 described below, when the search results are displayed to the user, advertisements that are targeted to the user and/or the search keywords are served to the user alongside the search results. An advertisement event is considered to occur when an advertisement is displayed or when the user actually clicks on an advertisement.

One embodiment of the host server 130 includes a user tracking and recording module 240. The user tracking and recording module 240 can be any combination of software agents and/or hardware components able to track and store search queries submitted by users, advertisements served to each user, and the responses of users to served advertisements. Information that is of interest includes the number of advertisements and the particular advertisements that are displayed to a user. This information is useful for when advertisers agree to provide compensation to users based upon the number of times an advertisement is shown (“eyeball” model).

In some embodiments, the user tracking and recording module 240 tracks and stores the number of times a user clicks upon an advertisement. This information is used in compensation models based upon pay per click (PPC).

One embodiment of the host server 130 includes a reward module 250. The reward module 250 can be any combination of software agents and/or hardware components able to determine the reward a registered user should receive based upon use of the search engine and responses to served advertisements.

In some embodiments, the user agrees to register with the system and provide registration information in exchange for a monetary reward. In this case, the reward module 250 calculates a share of the advertisement revenues that are earned by the user based upon information obtained by the user tracking and recording module 240. In some embodiments, a set of rules are used to perform the user revenue calculation. In one embodiment, for each search conducted by the user, a certain incentive is provided, for example $0.02.

In some embodiments, a model based upon user responses to the advertisements is used to calculate compensation. For example, an advertiser can agree to pay $1.00 each time a user clicks on an advertisement and further to share 20% of the payment with each registered user who actually clicks on the advertisement. When a user is served with the advertisement, and the user clicks on the advertisement, the user's account is credited with $0.20, while the advertiser's account is debited $1.00. Thus, for each advertisement that a user actively responds to, the user can earn a monetary reward.

In some embodiments, the user agrees to an incentive in the form of an affinity membership. In this case, the reward module 250 will provide appropriate levels of membership based upon frequency of usage of the search system, as tracked by the user tracking and recording module 240.

In some embodiments, the user agrees to be compensated by non-monetary incentives. For example, the system can provide discount coupons for particular categories of rewards, such as, restaurant coupons, clothing or shoe store coupons, etc., where the incentive may or may not be related to advertisements to which the user responded. Another example would be to provide a frequent user loyalty account that gets credited points when the user uses the system. The points can then be redeemed for rewards, either monetary or non-monetary.

One embodiment of the host server 130 includes a reporting module 280. The reporting module 280 can be any combination of software agents and/or hardware components able to provide information about a user's or advertiser's financial account. In some embodiments, a user or advertiser is required to provide authorization to the authentication module 230 before being permitted to access the financial account information. A user's account can include information about the number of advertisements served, the number of advertisements the user responded to, the total calculated reward for a given period of time, and how the reward was calculated. An advertiser's account can include information for each submitted advertisement regarding the number of times the advertisement was served, the number of responses received from users, the total amount owed by the advertiser for a given period of time, and how the amount owed was calculated.

One embodiment of the host server 130 includes a billing module 285. The billing module 285 can be any combination of software agents and/or hardware components able to provide billing information to advertisers based upon the agreed upon billing rates. In some embodiments, the billing module 285 can retrieve information from the advertiser's account database 144B and/or the general ledger 148 to acquire billing information. In some embodiments, the billing information can be sent by email over the network to the appropriate advertiser. Alternatively or additionally, a bill can be sent to the advertiser by mail.

In some embodiments, the billing module 285 can also provide compensation information to users based upon incentive rules of the system. In some embodiments, the billing module 285 can retrieve information from the user's account database 142B and/or the general ledger 148 to acquire compensation information. In some embodiments, the compensation information can be sent by email over the network to the appropriate user. Alternatively or additionally, compensation information can be sent to the user by mail.

One embodiment of the host server 130 includes an abuse prevention module 290. The abuse prevention module 290 can be any combination of software agents and/or hardware components able to monitor users and user responses. In some embodiments, the abuse prevention module 290 attempts to find users who sign up, for example, under multiple names in an effort to maximize the reward received for registering and agreeing to be served targeted advertisements. In some embodiments, the abuse prevention module 290 attempts to determine if a user is using automated searches to increase the amount of reward earned. Any abuse detected by the system could result in denying an abusive user access to the system.

FIG. 3A depicts a block diagram 300A illustrating an example of a user database 142 that stores user information 142A, and user account information 142B, according to one embodiment.

In the example of FIG. 3A, the user information is stored in database 142A. User information can include, but is not limited to, name, contact information, username, password, and submitted registration information.

The database 142 can also store content in user account database 142B. User account information can include, but is not limited to, financial account information, usage of search engine system, advertisements served to the user with accompanying search results, and user responses to served advertisements.

FIG. 3B depicts a block diagram 300B illustrating an example of an advertiser database 144 that stores advertiser information 144A, and advertiser account information 144B, according to one embodiment.

In the example of FIG. 3B, the advertiser information is stored in database 144A. Advertiser information can include, but is not limited to, name, contact information, authorized employees who are permitted to access the advertiser's account, username, password, and submitted registration information.

The database 144 can also store content in advertiser account database 144B. Advertiser account information can include, but is not limited to, financial account information and submitted advertisements.

FIG. 3C depicts a block diagram 300C illustrating an example of an advertisement database 146 that stores advertisement profile information 146A, advertisement content 146B, and an advertisement interaction log 146C, according to one embodiment.

In the example of FIG. 3C, the advertisement profile information is stored in database 146A. Advertisement profile information can include, but is not limited to, type of advertisement, type of payment model, maximum amount to be paid per advertisement event, times when an advertisement is to be or not to be displayed, keywords of searches for displaying advertisement, and target audience.

The database 146 can also store advertisement content in database 146B. Advertisement content can include, but is not limited to, textual content, audio content, image content, and video content.

The database 146 can store an advertisement interaction log 146C that includes the time when an advertisement event occurs, the advertisement, the event, and other related elements, such as user responses to advertisements.

FIG. 3D depicts a block diagram 300D illustrating an example of a general ledger database that stores user account information and advertiser account information, according to one embodiment.

In the example of FIG. 3D, the general ledger information is stored in database 148. General ledger information can include, but is not limited to, user, user account information, advertiser, advertiser account information, main account information.

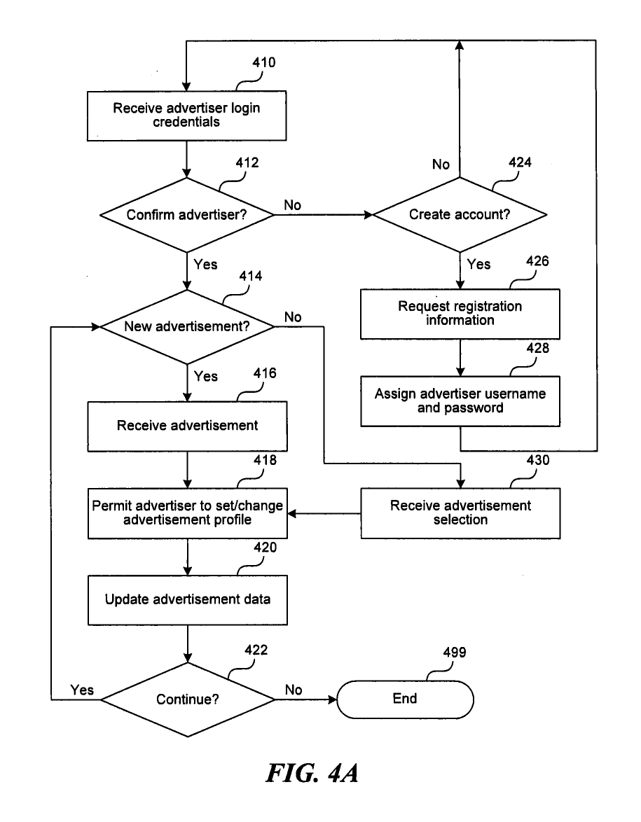

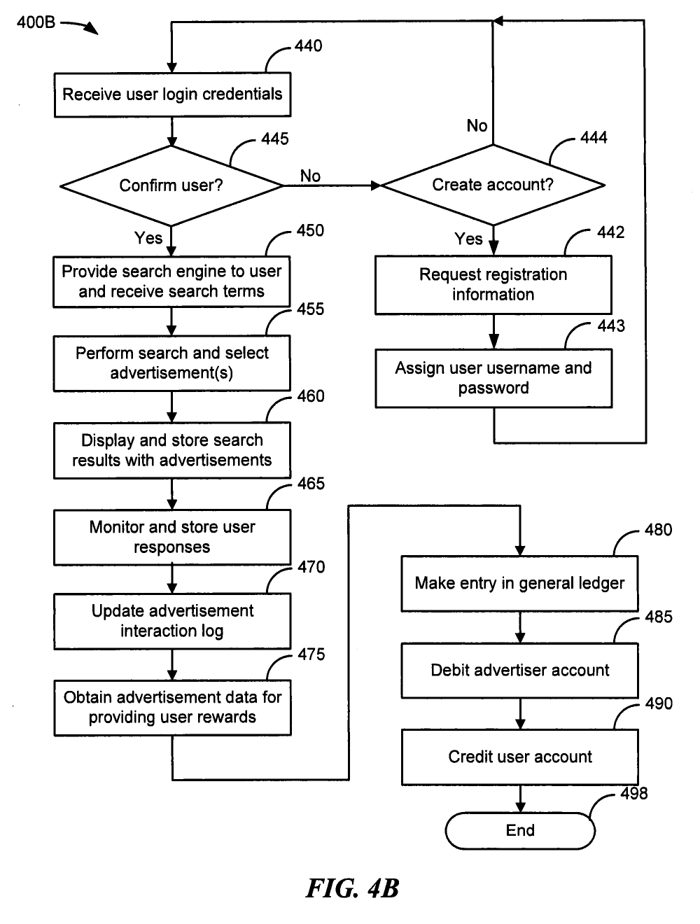

FIG. 4A depicts a flow diagram illustrating an exemplary process 400A of permitting an advertiser to log in to the search engine system to submit advertisements and to set or update advertisement parameters, according to an embodiment of the disclosure.

At block 410, the system receives an advertiser's login credentials. The credentials can include the advertiser's username and password.

At decision block 412, the system determines if the advertiser has an account with the system. If the advertiser does not have an account (block 412—No), the process continues to decision block 424. At decision block 424, the system asks the advertiser whether it wants to create an account with the system. If the advertiser does not want to create an account (block 424—No), the process returns to block 410. If the advertiser does want to create an account (block 424—Yes), at block 426 the system requests registration information, for example, advertiser name, contact information, and account information. Then at block 428, the system assigns the advertiser a unique username and password. In some embodiments, the advertiser can select a username and password. The process then returns to block 410.

If the advertiser does have an account (block 412—Yes), at decision block 414 the system asks whether the advertiser wants to submit a new advertisement to be displayed with search results. If the advertiser wants to submit a new advertisement (block 414—Yes), at block 416, the system receives the new advertisement. Then at block 418, the system receives profile information for the advertisement. Advertisement profile information can include, but is not limited to, type of advertisement, type of payment model, maximum amount to be paid per advertisement event, times when an advertisement is to be or not to be displayed, keywords of searches for displaying advertisement, and target audience.

Then at block 420, the system adds to or updates the advertisement database 146 with the submitted advertisement profile information. Subsequently, the new profile information will be used to decide whether the advertisement is to be selected for display with particular search results.

Next, at decision block 422 the system determines if the advertiser wants to add any other new advertisements or update any advertisement profiles. If the advertiser wants to continue (block 422—Yes), the process returns to decision block 414. If the advertiser is finished (block 422—No), the process ends at block 499.

At decision block 414, if the advertiser does not want to submit a new advertisement (block 414—No), the process continues to block 430 where the system receives from the advertiser a selection of a previously submitted advertisement for which the advertiser wants to change the profile information. The process continues to block 418 where the advertiser is permitted to change the selected advertisement's profile information, and the process continues to block 420, as described above.

FIG. 4B depicts a flow diagram illustrating an exemplary process 400B of permitting a registered user to log in to the search engine system to perform a search and receive remuneration, according to an embodiment of the disclosure.

At block 440, the system receives a search user's login credentials. The credentials can include the user's username and password.

At decision block 445, the system determines if the user has an account with the system. If the user does not have an account (block 445—No), the process continues to decision block 444. At decision block 444, the system asks the user whether he wants to create an account with the system. If the user does not want to create an account (block 444—No), the process returns to block 440. If the user does want to create an account (block 444—Yes), at block 442 the system requests registration information, for example, user name, contact information, and account information. Then at block 443, the system assigns the user a unique username and password. In some embodiments, the user can select a username and password. The process returns to block 440.

If the user does have an account (block 445—Yes), at block 450 the system provides a search engine interface to the user, and the system receives appropriate search terms from the user through the interface.

At block 455, the system performs the search and selects appropriate advertisements to serve alongside the search results based upon: the advertisement profile information provided by advertisers for their submitted advertisements at block 418 above; the user's questionnaire responses: the user's history of search queries; and the user's responses to served advertisements and search results. In some embodiments, the system stores the advertisements displayed to the user in the user's account in database 142B.

After serving the search results with advertisements, block 460, at block 465 the system monitors the user's responses. Responses can include no response, clicking on the advertisement, and scrolling through the advertisement. Additionally, time spent scrolling through an advertisement can be monitored as well as whether a user purchases a product or service based upon an advertisement. In some embodiments, user responses are also stored in the user's account in database 142B.

At block 470, the system updates the advertisement interaction log in database 146B. Updates can include, but are not limited to, tracking a user's usage of the system, the time an advertisement event occurs, the advertisement, the event, and other related elements. Then at block 475, the system obtains advertisement data from the advertisement profile information to determine the amount and/or kind of rewards the user is entitled to.

In some embodiments, the user is provided monetary compensation for being a willing participant, for example, the user is provided a predetermined percentage of the revenues paid by the advertiser for having a particular advertisement served. At block 480, in some embodiments the system updates the general ledger in database 148 with the amount of money to be paid to the user and the amount of money to be debited from the advertiser for serving the advertisement to the user. At block 485, in some embodiments, the advertiser's account in database 144B is debited, and at block 490 the user's account in database 142B is credited. In some embodiments, the user's account is credited with other suitable incentive rewards.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

What is claimed is:

1. A system, comprising:
a registration module operable to register users and advertisers and create user accounts and advertiser accounts;
an advertisement management module operable to receive advertisement profile information for each advertisement from advertisers;
a search engine and advertisement server module operable to perform searches responsive to search queries and select targeted advertisements to serve with search query results;
a user tracking module operable to monitor and store user usage information, wherein the search engine and advertisement server module adapts the search query results and the selected targeted advertisements based at least upon the user usage information stored by the user tracking module; and
a reward module operable to determine incentives earned by registered users based at least upon the user usage information stored by the user tracking module, wherein the user's account is credited and the advertiser's account is debited based at least upon the user usage information stored by the user tracking module.

2. The system of claim 1, further comprising:
a reporting module operable to provide information about a user's financial account or an advertiser's financial account to authorized inquirers.

3. The system of claim 1, further comprising:
a billing module operable to provide billing information to advertisers based at least upon the advertiser's financial account.

4. The system of claim 1, further comprising:
an authentication module operable to authenticate and associate a user with an existing user account and authenticate and associate an advertiser with an existing advertiser account.

5. The system of claim 1, further comprising an abuse prevention module operable to determine whether a user is abusing the system.

6. The system of claim 1 wherein advertisement profile information comprises a payment model and a target audience.

7. The system of claim 1 wherein the incentives are monetary and increase based at least upon a first number of searches conducted by the user and a second number of advertisements responded to by the user.

8. The system of claim 1 wherein user usage information comprises user search queries, search results, served advertisements, and user responses to the served advertisements.

9. The system of claim 8 wherein user responses to the served advertisements comprises clicking on advertisements, scrolling through advertisements, and purchasing products or services based upon an advertisement.

10. A computer-implemented method, comprising:
receiving one or more advertisements with profile information from an advertiser;
receiving a search request from a user;
performing a search based on the search request;
providing search results to the user with at least one targeted advertisement;
tracking and recording a user's search requests, the search results, the at least one targeted advertisement, and the user's responses to the at least one targeted advertisement, wherein the search results and the at least one targeted advertisement are based at least upon previously tracked and recorded information;
billing the advertiser for serving the at least one targeted advertisement to the user; and
determining an incentive to be provided to the user.

11. The method of claim 10, further comprising:
receiving registration information from the user and creating a user account, wherein the registration information includes answers to a questionnaire to determine a profile of the user.

12. The method of claim 10, further comprising:
crediting the user account with the incentive.

13. The method of claim 10, further comprising:
authenticating the user prior to performing the search.

14. The method of claim 10, further comprising:
providing information about a user's determined incentive or an advertiser's bill in response to an authorized inquiry.

15. The method of claim 10 wherein determining the incentive to be provided comprises calculating a predefined percentage of an advertiser's payment each time the user responds to a targeted advertisement.

16. The method of claim 10 wherein profile information comprises a payment model and a target audience.

17. The method of claim 10 wherein responses to the targeted advertisements comprise clicking on advertisements, scrolling through advertisements, and purchasing products or services based upon an advertisement.

18. A computer-readable medium encoded with processing instructions for implementing a method performed by a computer, the method comprising:
receiving one or more advertisements with profile information from an advertiser;
receiving a search request from a user;
performing a search based on the search request;
providing search results to the user with at least one targeted advertisement;
tracking and recording a user's search requests, the search results, the at least one targeted advertisement, and the user's responses to the at least one targeted advertisement, wherein the search results and the at least one targeted advertisement are based at least upon previously tracked and recorded information;
billing the advertiser for serving the at least one targeted advertisement to the user; and
determining an incentive to be provided to the user.

19. The method of claim 18, further comprising:
receiving registration information from the user, wherein the registration information includes answers to a questionnaire to determine a profile of the user, and further wherein the registered user receives the incentive for submitting a search request and responding to targeted advertisements.

20. A computer-implemented method, comprising:
means for receiving one or more advertisements with profile information from an advertiser;
means for receiving a search request from a user;
means for performing a search based on the search request;
means for providing search results to the user with at least one targeted advertisement;
means for tracking and recording a user's search requests, the search results, the at least one targeted advertisement, and the user's responses to the at least one targeted advertisement, wherein the search results and the at least one targeted advertisement are based at least upon previously tracked and recorded information;
means for billing the advertiser for serving the at least one targeted advertisement to the user;
means for determining an incentive to be provided to the user based at least on the user's response to the at least one targeted advertisement.

21. A system, comprising:
a registration module operable to register users and advertisers and create user accounts and advertiser accounts;
an advertisement management module operable to receive advertisement profile information for each advertisement from advertisers;
an advertisement server module operable to select targeted advertisements to serve with other content;
a user tracking module operable to monitor and store user usage information, wherein the advertisement server module adapts the selected targeted advertisements based at least upon the user usage information stored by the user tracking module; and
a reward module operable to determine incentives earned by registered users based at least upon the user usage information stored by the user tracking module, wherein the user's account is credited and the advertiser's account is debited based at least upon the user usage information stored by the user tracking module.

22. A computer-implemented method for sharing advertisement revenue with a user, comprising:
receiving one or more advertisements with profile information from an advertiser;
receiving registration information from the user and creating a user account, wherein the registration information includes answers to a questionnaire for determining a profile of the user;
providing to the user at least one targeted advertisement with other content;
tracking and recording the user's responses to the at least one targeted advertisement, wherein the at least one targeted advertisement are based at least upon previously tracked and recorded information;
billing the advertiser for serving the at least one targeted advertisement to the user;
determining an incentive to be provided to the user; and
crediting the user account with the incentive.
